(19) United States
(12) Patent Application Publication
(10) Pub. No.: US 2014/0068870 A1
(43) Pub. Date: Mar. 13, 2014

(54) TOOL ARTICLE

(71) Applicant: Nicole Runnels, Atlanta, GA (US)

(72) Inventor: Nicole Runnels, Atlanta, GA (US)

(21) Appl. No.: 13/613,537

(22) Filed: Sep. 13, 2012

(51) Int. Cl. B25F 1/00

(52) U.S. Cl. CPC B25F 1/00
USPC 7/169

(57) ABSTRACT

A tool article comprises at least five arms radiating outwardly within a generally disc-shaped region from a center region, each of the arms having a proximal end near the center region and a distal end having a shape corresponding to a shape of an end of a hand tool.

### BACKGROUND

Common hand tools include hammers, wrenches, screwdrivers, pliers, and the like. It would be desirable to provide a single article that includes more than one of these tools in a convenient form.

### SUMMARY

Embodiments of the present invention relate to a tool article, comprising at least five arms radiating outwardly within a generally disc-shaped region from a center region, each of the arms each having a proximal end near the center region and a distal end having a shape corresponding to a shape of an end of a hand tool.

Other systems, methods, features, and advantages of the invention will be or become apparent to one of skill in the art to which the invention relates upon examination of the following figures and detailed description. All such additional systems, methods, features, and advantages are encompassed by this description and the accompanying claims.

### BRIEF DESCRIPTION OF THE FIGURES

The invention can be better understood with reference to the following figures. The elements shown in the figures are not necessarily to scale, emphasis instead being placed upon clearly illustrating the principles of the invention. Also, in the figures like reference numerals designate corresponding elements throughout the different views.

FIG. 1 is a perspective view of the tool article, in accordance with an exemplary embodiment.

FIG. 2 is a top plan view of the tool article of FIG. 1.

FIG. 3 is a bottom plan view of the tool article of FIG. 1.

FIG. 4 is a side elevation view of the tool article of FIG. 1.

### DETAILED DESCRIPTION

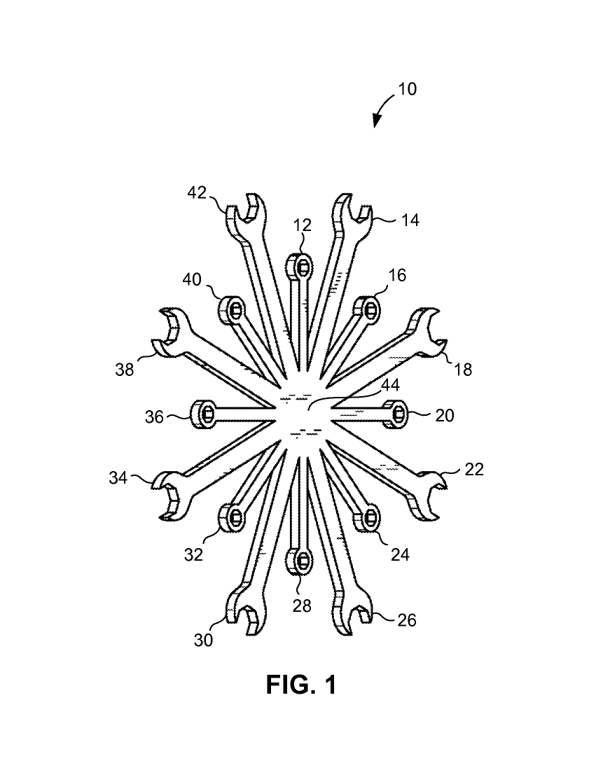

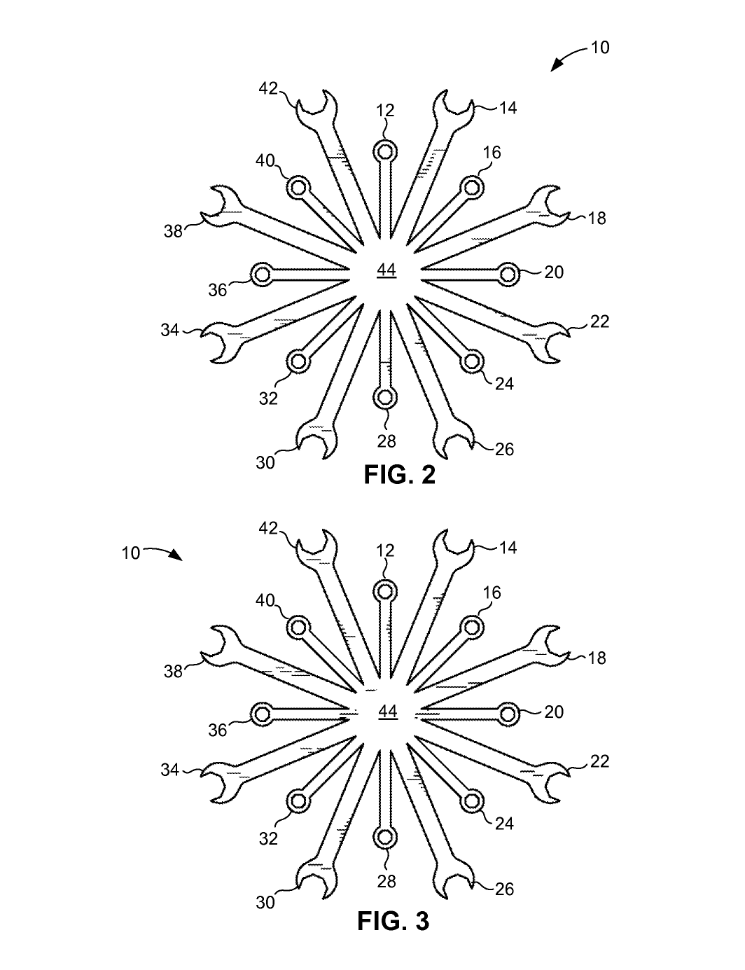

As illustrated in FIGS. 1-4, in an illustrative or exemplary embodiment of the invention, a tool article 10 includes sixteen arms 12, 14, 16, 18, 20, 22, 24, 26, 28, 30, 32, 34, 36, 38, 40 and 42. Arms 12-42 radiate outwardly from a center region 44, defining a star-like shape. Each of arms 12-42 includes a proximal end near the center region 44. Arms 12-42 are evenly spaced around center region 44. That is, in the exemplary embodiment arms 12-42 are disposed in a radially symmetric manner with respect to center region 44.

In the exemplary embodiment, the distal end of each of arms 12, 16, 20, 24, 28, 32, 36 and 40 has a shape corresponding to a hand tool commonly known as a box wrench or ring wrench. Similarly, the distal end of each of arms 14, 18, 22, 26, 30, 34, 38 and 42 has a shape corresponding to a hand tool commonly known as an open-end wrench. (It can be noted that the term “wrench” is used in American English to refer to such a hand tool, while “spanner” is used in British English.)

Although the tool article 10 includes sixteen arms 12-42, in other embodiments a tool article can include any number of arms greater than or equal to five. It has been discovered that five or more arms is optimally convenient because, regardless of in what orientation a person picks up the tool article 10, the person will essentially never need to rotate the tool article in his hand more than a few degrees to direct the distal end toward a workpiece.

Although in the exemplary embodiment the distal end of each arm has a shape corresponding to a type of wrench, in other embodiments the distal end of each arm can have a shape corresponding to other types of hand tools, such as a screwdriver, nutdriver, awl, pliers, hammer, etc. The term “hand tool” as used herein is intended to refer to the category of tools that have been traditionally used upon nuts, bolts, screws, nails, and related workpieces. As well understood in the art, hand tools of the type referred to herein are staple items sold in hardware or home improvement stores.

Also, it can be noted that in the exemplary embodiment arms 12, 16, 20, 24, 28, 32, 36 and 40 alternate with arms 14, 18, 22, 26, 30, 34, 38 and 42. That is, each one of arms 12, 16, 20, 24, 28, 32, 36 and 40 is adjacent one of arms 14, 18, 22, 26, 30, 34, 38 and 42. Thus, box wrench or ring wrench distal ends alternate with open-end wrench distal ends. However, in other embodiments, rather than two types of wrench distal end types alternating with each other, two or more distinct hand tool types can alternate with each other. For example, in another embodiment (not shown) arms having distal ends corresponding to a wrench can alternate with arms having distal ends corresponding to screwdrivers. Also, although in the exemplary embodiment tool article 10 has arms 12-42 with two types of distal ends, (i.e., box wrench distal ends and open-end wrench distal ends), in other embodiments a tool article can have more than two types of distal ends. For example, a tool article in such other embodiment can have one or more arms with distal ends corresponding to wrenches, one or more arms with distal ends corresponding to screwdrivers, and one or more arms with distal ends corresponding to pliers.

In such other embodiments, arms having different types of distal ends can be arranged in patterns other than the alternating pattern described above. That is, arms having different types of distal ends can be arranged in any suitable symmetric manner, such as, for example, an arm having a screwdriver distal end interposed between every pair of adjacent arms having a wrench distal end.

Although in the exemplary embodiment the distal end of each arm has a shape corresponding to the portion of the hand tool that is adapted to grip a workpiece (e.g., the end of a wrench is adapted to grip a bolt), in other embodiments the distal end of at least some of the arms can have a shape corresponding to the portion of the hand tool that is adapted to be gripped by a user (i.e., the handle of the tool). For example, the distal end of at least some of the arms can have a shape corresponding to a screwdriver handle (i.e., the end that is adapted to be gripped by a user) rather than a screwdriver tip (i.e., the end that is adapted to drive a screw).

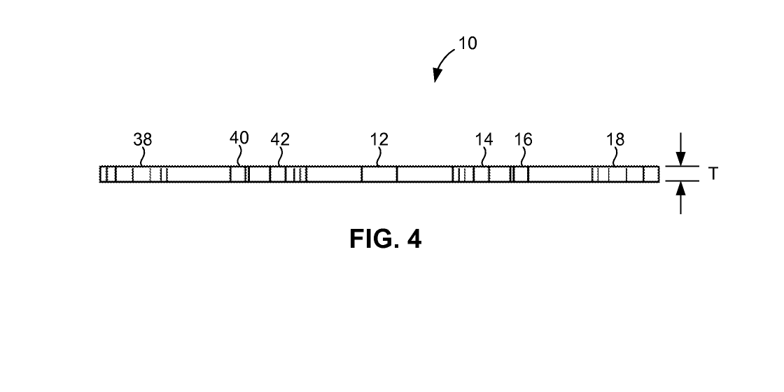

Note that in the exemplary embodiment each arm 12-42 has an edge adjacent to an edge of another one of arms 12-42. Each arms 12-42 also has two opposing faces. As shown in FIG. 4, the distance between opposing faces of arms 12-42 defines a thickness “T” of a generally disc-shaped region within which arms 12-42 are disposed.

While one or more embodiments of the invention have been described as illustrative of or examples of the invention, it will be apparent to those of ordinary skill in the art that other embodiments are possible that are within the scope of the invention. Accordingly, the scope of the invention is not to be limited by such embodiments but rather is determined by the appended claims.

1. A tool article, comprising:
at least five arms radiating outwardly within a generally disc-shaped region from a center region, each of the arms having a proximal end near the center region and a distal end having a shape corresponding to a shape of an end of a hand tool;
wherein the at least five arms are symmetrically and evenly spaced from each other with respect to the center region.

2. The tool article of claim 1, wherein each arm has edges adjacent to edges of others of the arms and has two planar opposing faces, a distance between the opposing faces defining a thickness of the disc-shaped region.

3. (canceled)

4. The tool article of claim 1, wherein the distal ends of at least two of the arms have shapes corresponding to shapes of a workpiece-engaging end of a hand tool.

5. The tool article of claim 1, wherein the at least five arms and the center region are unitarily formed together in a single piece of material.

6. The tool article of claim 1, wherein the distal ends of at least one of the arms has a shape corresponding to a shape of a portion of a hand tool that is adapted to be gripped by a user.

7. A tool article, comprising:
at least five arms radiating outwardly from a center region, each of the arms having a distal end having a shape corresponding to a hand tool end shape, and the distal ends including at least two types of hand tool end shapes.

8. The tool article of claim 7, wherein the at least five arms are symmetrically and evenly spaced from each other with respect to the center region.

9. The tool article of claim 7, wherein the at least five arms and the center region are unitarily formed together in a single piece of material.

10. The tool article of claim 7, wherein the distal ends of at least two of the arms have shapes corresponding to shapes of a workpiece-engaging end of a hand tool.

11. A tool article, comprising:
at least five arms radiating outwardly from a center region, each of the arms having a distal end having a shape corresponding to a hand tool end shape;
wherein at least one of the distal ends has a shape corresponding to a shape of a portion of a hand tool that is adapted to be gripped by a user, and at least one of the other distal ends has an open-end wrench distal end shape.

12. The tool article of claim 11, wherein the at least five arms are symmetrically and evenly spaced from each other with respect to the center region.

13. The tool article of claim 11, wherein the at least five arms and the center region are unitarily formed together in a single piece of material.
